(19) United States
(12) Patent Application Publication
(10) Pub. No.: US 2004/0061739 A1
(43) Pub. Date: Apr. 1, 2004

(54) Carriages for printing devices

(76) Inventors: Richard H. Lewis, Barcelona (ES); Curt Torgesson, Barcelona (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/450,167

(22) PCT Filed: Dec. 19, 2000
(86) PCT No.: PCT/EP00/12951

(51) Int. Cl. B41J 2/175

(52) U.S. Cl. 347/37; 347/85

(57) ABSTRACT

An ink-jet printer (100) has a movable print carriage (120) carrying a printhead (130) which is supplied with ink from a fixed reservoir (150) via an intermediate portion (135) mounted on a second movable carriage (140). The intermediate portion (135) is connected to the reservoir (150) by first tubing (151), and to the printhead (130) by second tubing (152), the second carriage (140) serving to decouple forces from the print carriage (120) which would lead to deterioration in print quality. The carriages (120, 140) are moved along common longitudinal guides (123, 124) by a drive belt (160). The carriages may be arranged end-to-end or partially overlapping; alternatively one (840, 940) may straddle or enclose the other.

The present invention relates to ink-jet printing devices, such as printers, copiers, facsimile machines and combined devices, and to the carriages for mounting the printheads thereof. In particular the invention relates to the way in which ink is conveyed from a fixed reservoir to the printhead of an ink-jet printer.

Printing devices are known in which the print carriage itself carries cartridges of the various colours of ink required to undertake printing. However, in these printers, the cartridges need to be replaced or refilled at regular intervals and this is a disadvantage, especially with large-format printers.

A previous solution to this problem is to provide relatively large ink reservoirs fixed in relation to the printer and connected by means of a flexible tubing system to the pens on the moving print carriage. This avoids the need to interrupt a printing operation to replenish the ink supply. However, such a printer arrangement has a number of disadvantages. For example, the print quality of images produced can deteriorate because dot placement errors occur, which are caused by vibrations induced by the tubing system in the print carriage. Such vibrations occur when the tubing rapidly reverses direction or when it impacts with part of the printer.

Another disadvantage is that the tubing system exerts twisting moments upon the print carriage which can produce rotation of the print carriage about its guides. This can also reduce the print quality and, in bi-directional printing, can introduce non-uniformity between the two directions of printing. The tubing system also adds to the effective mass of the print carriage, leading to the need for a high pre-load for the carriage bearing system. Because the print carriage has high requirements of precision, rigidity and strength, this limits the number of ink tubes and/or the diameters of the tubes which can be connected to it without effecting an unsatisfactory degradation of print quality.

The present invention seeks to overcome or reduce one or more of the above disadvantages.

According to the present invention, there is provided a printing device comprising a movable print carriage member carrying printhead means, and supply means not located on said carriage member for supplying ink and/or printing data to said printhead means via a flexible connection characterised in that said supply means are mounted on another carriage member which is movable in the same direction as the print carriage member.

In a preferred arrangement the carriage members are driven by a common drive member, e.g. a drive belt. The belt may have separate drive connections to each of the carriage members, which has the advantage that unwanted forces are not transmitted directly from one carriage to the other, but only indirectly via the drive belt to a relatively small extent.

Alternatively the device member may be directly connected to a first of the carriage members, said first carriage member being arranged to drive said second carriage member. In this case the first and second carriage members are interconnected by means of a drive connection which transmits forces only in the direction of motion which again has the advantage of reducing unwanted forces on the print carriage member.

In preferred embodiments, the drive member passes through, or relatively close to, the centre-of-gravity of said print carriage member. This has the advantage of reducing unwanted effects introduced by tilting movements.

The two carriage members may be arranged to overlap, at least partially, which saves space. Alternatively, space may be saved by one carriage member straddling or substantially enclosing the other carriage member.

Preferred embodiments of the present invention will now be described, by way of example only, with reference to the accompanying drawings, of which:

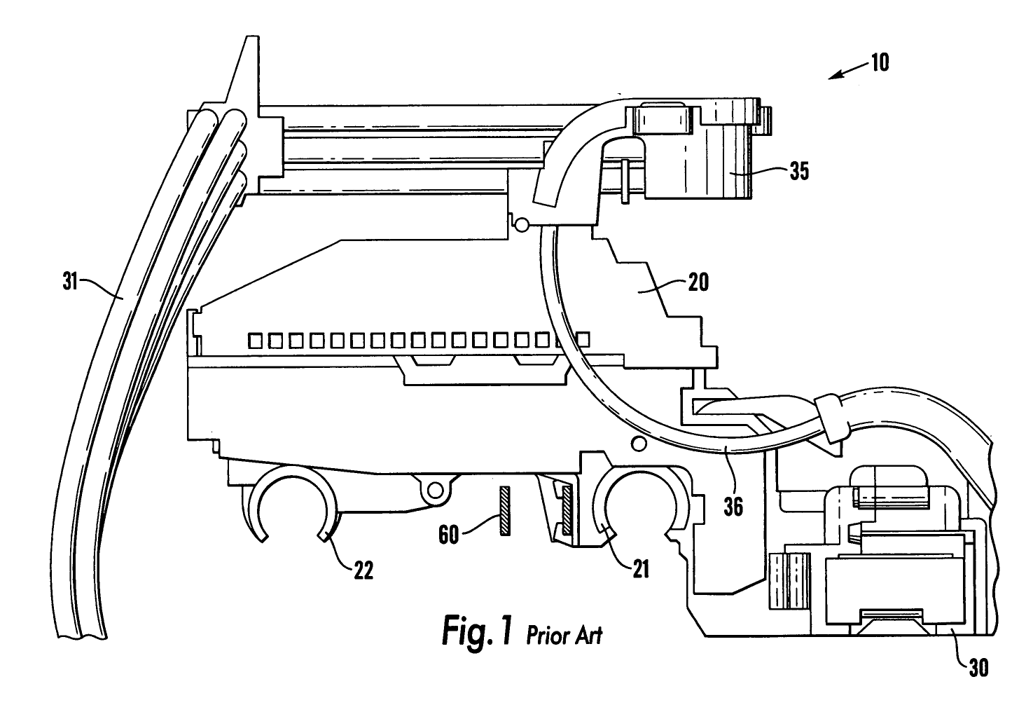

FIG. 1 shows the print carriage and ink supply arrangement of a prior art printing device;

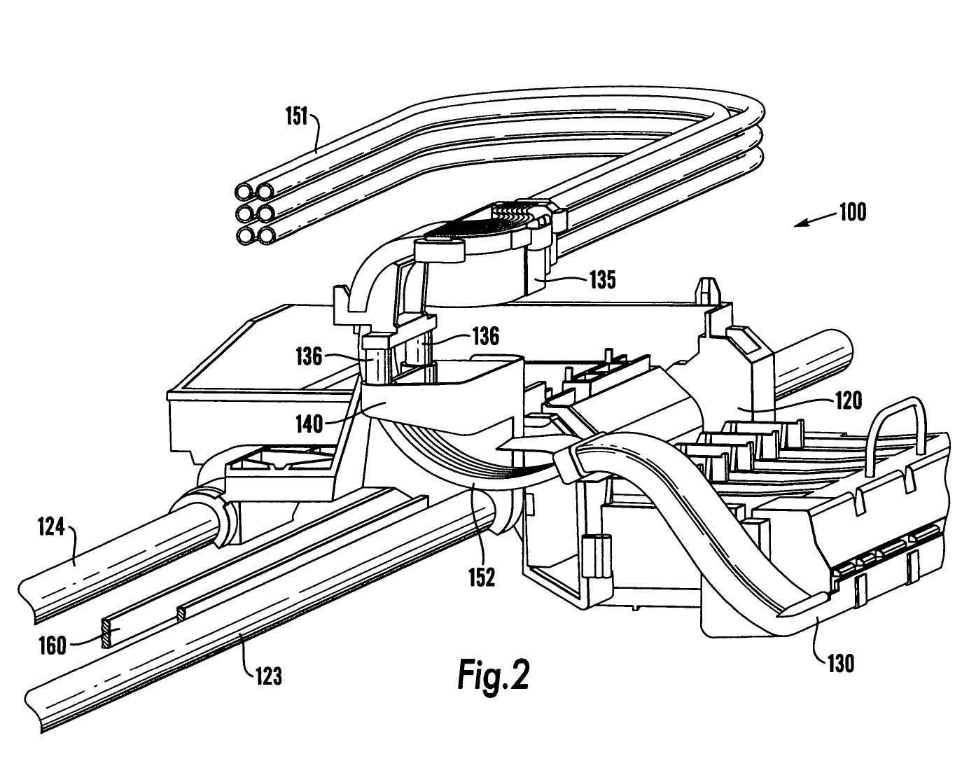

FIG. 2 shows a top front perspective view of a printing device in accordance with a first embodiment of the present invention;

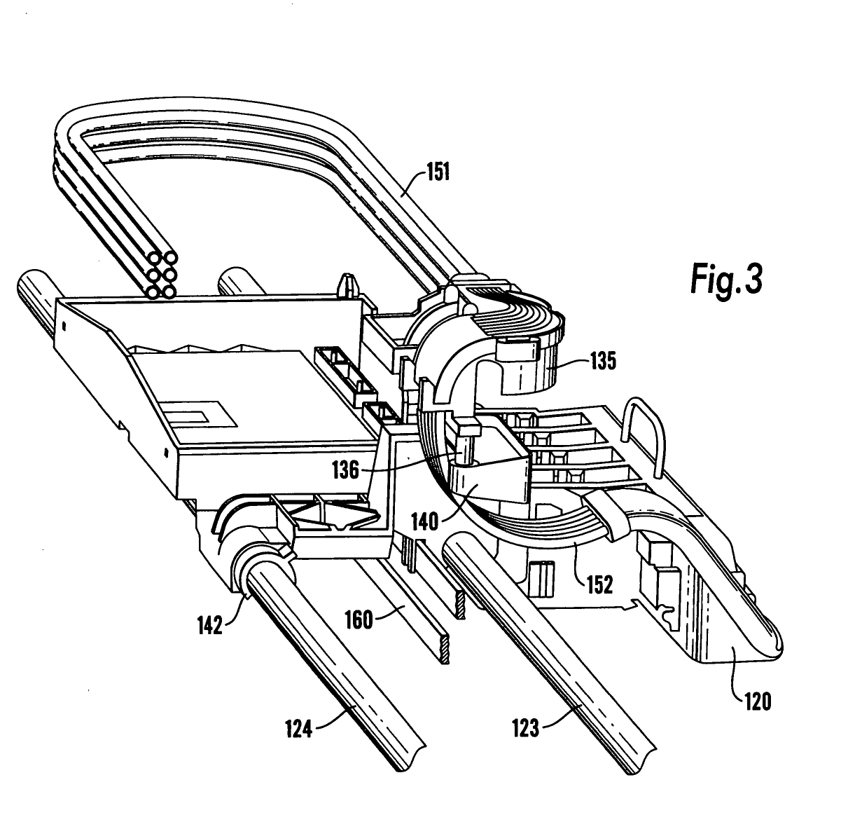

FIG. 3 shows a top rear perspective view of the printer of FIG. 2;

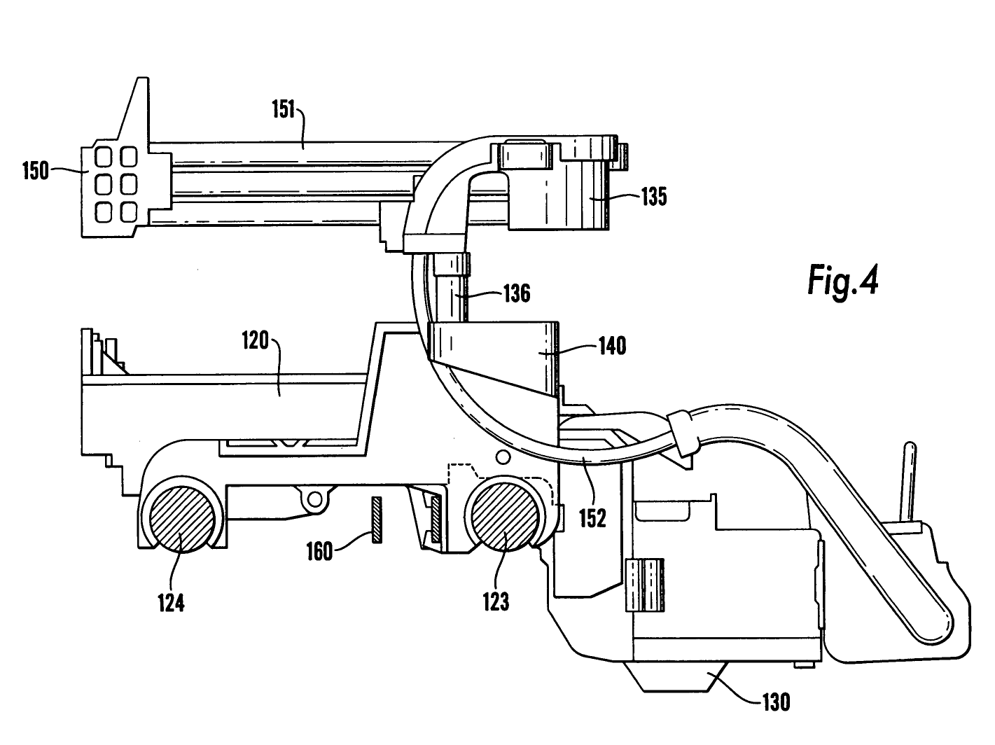

FIG. 4 shows an end view of the printer of FIG. 2;

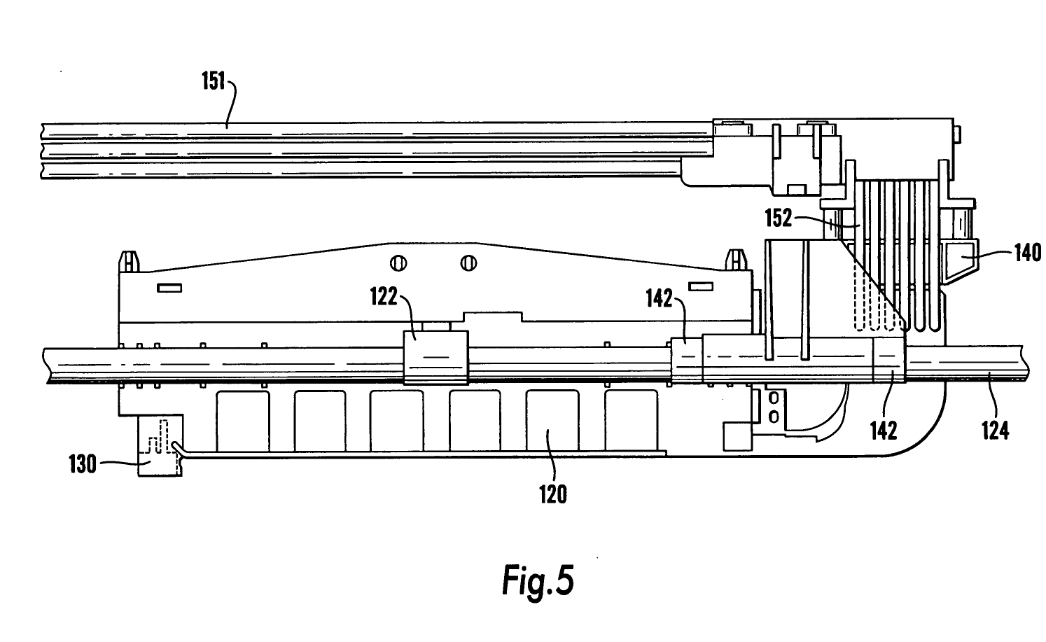

FIG. 5 shows a rear view of the printer of FIG. 2;

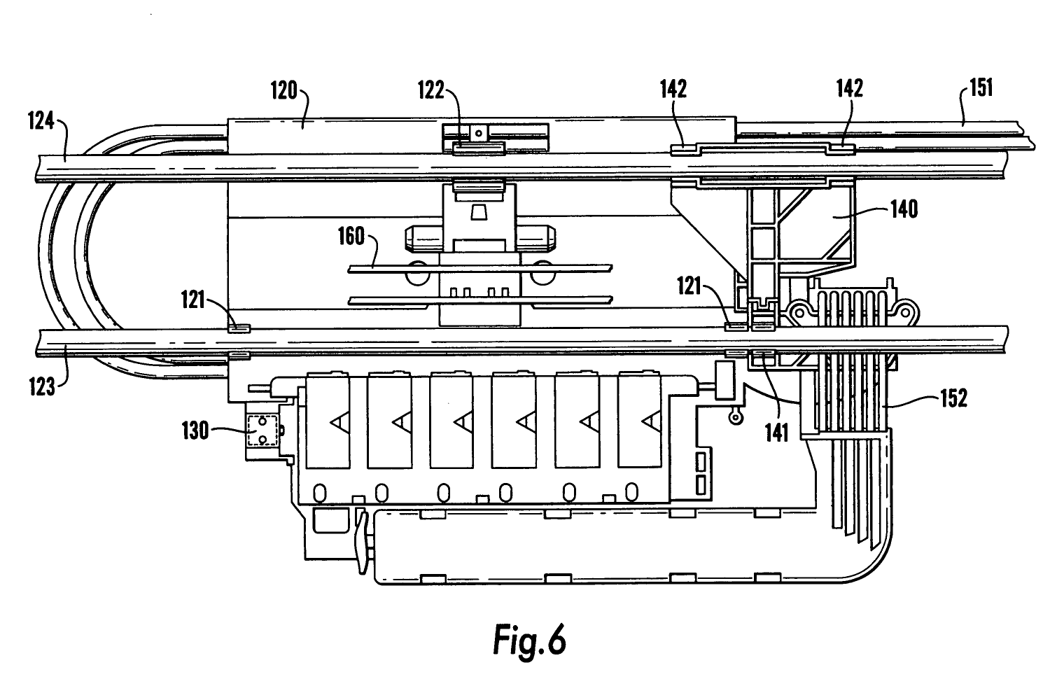

FIG. 6 shows an underneath plan view of the printer of FIG. 2;

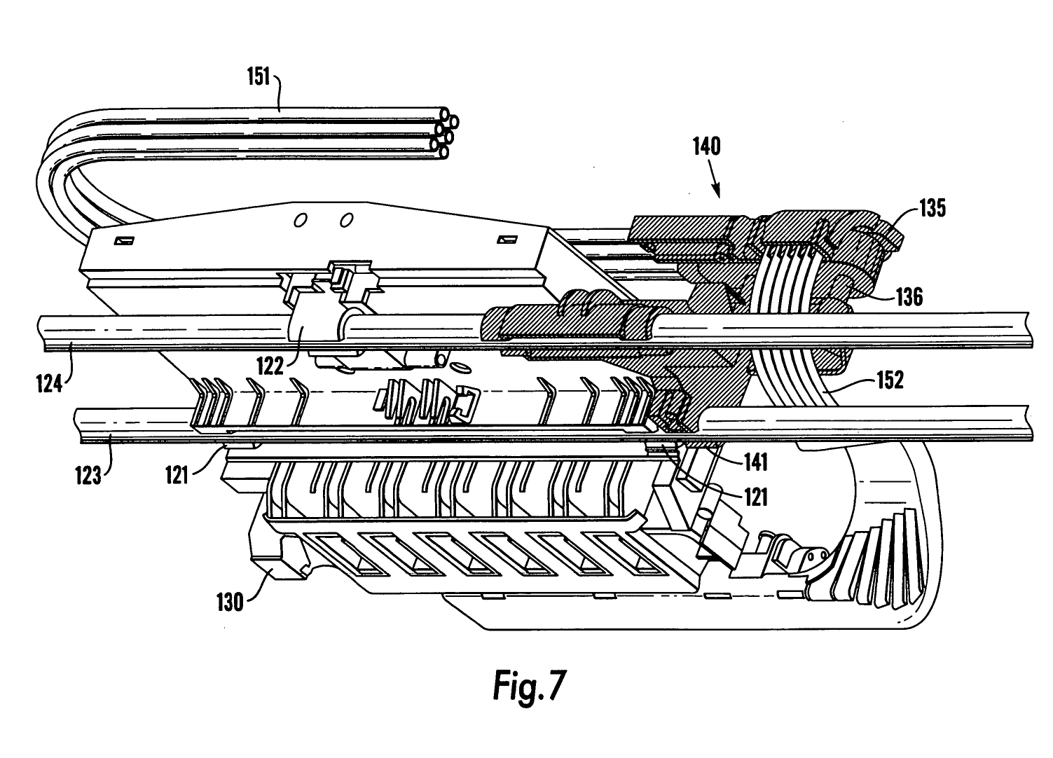

FIG. 7 shows a rear underneath perspective view of the printer of FIG. 2 in which the print carriage member is shown unshaded and the other carriage member is shown shaded;

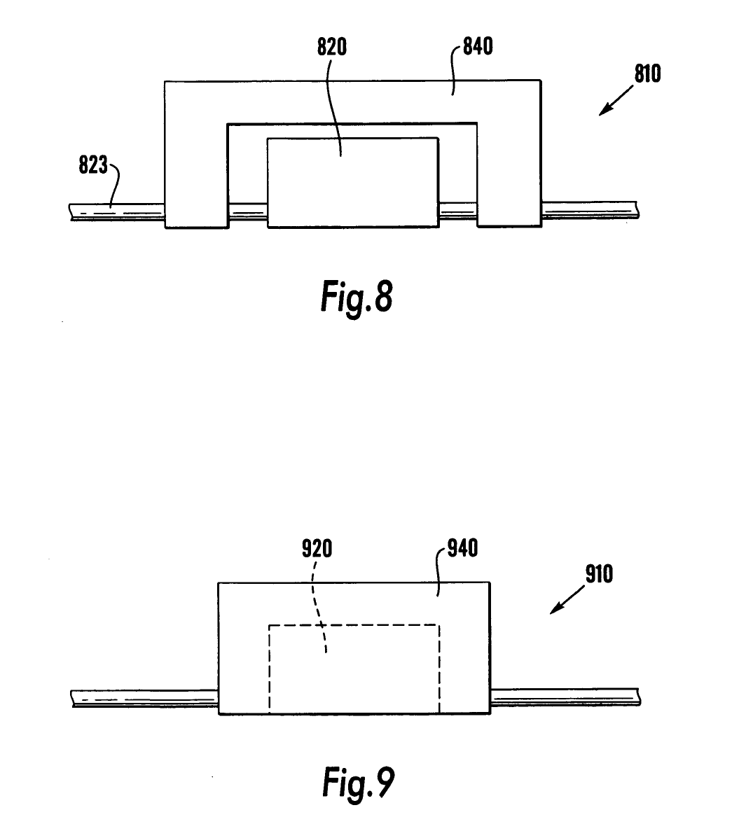

FIG. 8 shows a schematic view of a printer in accordance with a second embodiment of the present invention; and

FIG. 9 shows a schematic view of a printer in accordance with a third embodiment of the present invention.

Referring to FIG. 1, a prior art printer 10 comprises a print carriage 20 having front and rear bushings 21, 22 arranged to slide on respective front and rear longitudinal guides (not shown). The carriage 20 is driven by a reciprocating belt member 60. A printhead 30 comprising six colour pens is supplied with ink from six respective reservoirs (not shown) fixed to the printer chassis. The ink flows via first lengths of tubing 31, which lead to a crane 35 mounted directly on the print carriage 20, and second lengths of tubing 36 extending from the crane to the printhead 30. In order to allow print carriage 20 to move freely between the ends of the printer 10, tubing 31 needs to be quite long, which means that it is relatively heavy and repeatedly impacts with various parts of the printer.

Referring now to FIGS. 2 to 7, a printer 100 in accordance with the present invention comprises a print carriage 120 having a six-pen printhead 130 and front bushings 121 arranged to slide on a front bar guide 123, and a rear bushing 122 arranged to slide on a rear bar guide 124. Carriage 120 is driven by a reciprocating belt member 160. The printer 100 further comprises a second carriage 140 which has a front bushing 141 arranged to slide on guide 123 and rear bushings 142 arranged to slide on guide 124. Carriage 140 is driven by the same reciprocating belt member which drives carriage 120. The upper region of carriage 140 comprises a crane portion 135 connected to the rest of carriage 140 by two cylindrical pillars 136. An ink supply arrangement 150 fixed to the printer housing comprises six reservoirs for different inks. The reservoirs are connected by means of six relatively long lengths of flexible tubing 151 to first ends of respective internal passageways of the crane portion 135. The other ends of the internal passageways are connected via six relatively short lengths of flexible tubing 152 to respective pens of the printhead 130. Since carriage 140 decouples the effects of the mass and the movements of tubing 151 from the print carriage 120, the carriage 140 is referred to as the “decoupling” carriage.

The print carriage 120 and the decoupling carriage 140 are connected to respective parts of their common drive belt member such that they are driven in synchronism but do not touch each other. To save space, however, one of the rear bushings 142 of the decoupling carriage 140 is located underneath part of the print carriage 120 as shown in FIG. 5.

In use, the print carriage 120 moves from end to end of the printer to perform successive passes across the print medium between advances thereof. As ink leaves the six printing pens it is replaced by ink from tubing 152 which, in turn, is replaced by ink from tubing 151 and reservoir 150.

The above-described arrangement has various advantages. In particular, by dividing the functionality between the two carriages, it allows print carriage 120 to be designed as a precision, relatively lightweight structure with the decoupling carriage 140 serving as a structure to bear coarse loads and not requiring a precise bearing arrangement. The bushings of carriage 140 could be constructed integrally, and optionally comprise insets of polytetrafluoroethylene material. Vibrations and twisting of the long tubing 151 do not adversely effect print quality; the tubing 152 effectively moves together with the carriages and thus does not produce the same problems.

The pre-load on the print carriage 120 can be reduced; alternatively, the number and/or size of the ink tubes can be increased without adversely affecting print quality and/or carriage 120 can be heavier and/or the printer may operate more quickly.

The above-described arrangement also allows a modular and platform approach to the construction of the printer. For example, a lightweight print carriage construction optimised for a normal sized printer, or a printer that does not have tubes, could also be used in a plotter or large format printer without substantial modification by using a decoupling carriage to avoid the higher forces, moments and vibrations being transmitted to the print carriage.

Numerous modifications can be made to the above-described arrangement. For example, instead of the construction of tubing 152 being similar to that of tubing 151, it can be at lower stiffness and/or of smaller cross-section to further reduce the transmission of forces. Alternatively, tubing 151 could extend through the internal passageways of crane portion 135 so as to be continuous with tubing 152. Instead of reservoir 150 being fixed, it could be mounted on the carriage 140 with tubing 151 being omitted; this would increase the weight of carriage 140, but it would still be decoupled from the print carriage 120. An advantage of this modification is that the ink reservoir or tanks would be on or close to the longitudinal axis along which the carriages move. Compensation can be made for the increased inertia of the decoupling carriage by introducing resilience (eg by means of a spring) into its drive coupling.

Flexible wiring may be provided in parallel with tubing 151 and 152 to provide printing instructions to the printhead. Indeed the flexible wiring can be the only connection between the carriages, in which case conventional print cartridges are provided on the printhead.

In preferred arrangements, the belt drive axis is arranged to pass through or near the centre of gravity of the print carriage 120, i.e. in the vicinity of front bar guide 123. In modifications, the belt axis may be displaced from the centre-of-gravity, for example near to rear bar guide 124 or adjacent printhead 130. In these modifications, the decoupling carriage 140 serves to remove the adverse effects caused by the belt drive axis not passing through the centre-of-gravity of the print carriage 120. Any tilting movements are absorbed by the carriage 140 and not passed on to carriage 120.

Instead of being connected to both carriages 120, 140, the belt drive 160 may be directly connected to only one of them, preferably the decoupling carriage, in which case a suitable non-influencing drive connection is provided between the two carriages. Such a connection might comprise one or more touch points, e.g. where a spherical surface engages a flat surface. Alternatively, the drive connection may be a two-dimensional hinge device, which may be a simple flap of material so that the two carriages can be manufactured as an integral component comprising the carriage portions interconnected by the flap. Alternatively, the drive connection can also comprise one or more wires. The drive connection should be such that forces between the two carriages are only transmitted in the direction of motion along the printer, and that forces and movements in other directions are not transmitted.

Instead of the partially-overlapping disposition as shown, the two carriages may be arranged end-to-end. However, if the distance between the two bushings of a carriage travelling on the same guide is reduced too far, there is a tendency for the carriage to rock about an axis perpendicular to the guide.

In another modification, separate longitudinal guides may be provided for the decoupling carriage 140, in which case the carriage members can be arranged side-by-side or one above the other instead of being spaced longitudinally of each other. This modification also permits different types of guides to be used for the carriages. For example, the decoupling carriage can travel on wheels, which are effective in eliminating unwanted moments induced by the tubing.

Drive mechanisms other than a belt drive system may be employed.

FIG. 8 shows a printer 810 in accordance with a second embodiment of the present invention, in which decoupling carriage 840 is mounted on the same guides 823 as the print carriage 820 and straddles the latter.

FIG. 9 shows a printer 910 in accordance with a third embodiment of the present invention, in which the decoupling carriage 940 completely encloses the print carriage 920.

The same modifications may be made to the embodiments of FIG. 8 and 9 as disclosed in connection with the first embodiment.

The carriage arrangement may form part of other printing devices such as copiers, facsimile machines and combined devices, including so-called “all-in-one” devices.

1. A printing device (100) comprising a movable print carriage member (120) carrying printhead means (130), and supply means (135) not located on said carriage member for supplying ink and/or printing data to said printhead means via a flexible connection characterised in that said supply means (135) are mounted on another carriage member (140) which is movable in the same direction as the print carriage member (120).

2. A printing device according to claim 1, wherein the carriage members (120, 140) are driven by a common drive system (160).

3. A printing device according to claim 2, wherein the drive system comprises a drive member (160) which has separate respective driving connections to each of the carriage members (120, 140).

4. A printing device according to claim 2, wherein the drive system comprises a drive member which is directly connected to a first of the carriage members, said first carriage member being arranged to drive said second carriage member.

5. A printing device according to claim 4, wherein said first and second carriage members are interconnected by means of a drive connection which transmits forces only in the direction of motion.

6. A printing device according to any of claims 3 to 5, wherein said drive member (160) passes through, or relatively close to, the centre-of-gravity of said print carriage member.

7. A printing device according to any of claims 3 to 5, wherein said drive member is relatively remote from the centre-of-gravity of said print carriage member.

8. A printing device according to any preceding claim, wherein the carriage members (120, 140) move along common longitudinally-extending guide means (123, 124).

9. A printing device according to any of claims 1 to 7, wherein each carriage member moves along its own respective longitudinally-extending guide means.

10. A printing device according to any preceding claim, wherein the carriage members are arranged end-to-end in the direction of movement.

11. A printing device according to any of claims 1 to 9, wherein the carriage members (120, 140) overlap partially in the direction of movement.

12. A printing device according to any of claims 1 to 9, wherein one of the carriage members (840) straddles the other carriage member (820) in the direction of movement.

13. A printing device according to any of claims 1 to 9, wherein one of the carriage members (940) substantially encloses the other carriage member (920).

14. A printing device according to any preceding claim, comprising ink reservoir means (150) fixed to a housing of the printing device, the ink reservoir means being coupled to the supply means (135) by means of a first length of flexible tubing means (151) and the supply means (135) being coupled to the printhead means (130) by means of a second length of flexible tubing means (152).
